(19) United States
(12) Patent Application Publication
(10) Pub. No.: US 2007/0052387 A1
(43) Pub. Date: Mar. 8, 2007

(54) Automotive engine-starting battery

(76) Inventors: Chin-Fa Yen, Taipei County (TW); Kuo-Pin Yen, Taipei (TW)

Correspondence Address: TB05P0075US, P.O. Box 44 - 2049, Taipei, 10668, TW

(21) Appl. No.: 11/218,685

(22) Filed: Sep. 6, 2005

(51) Int. Cl. H02J 7/00

(52) U.S. Cl. 320/109

(57) ABSTRACT

This invention presented is an automotive engine-starting battery, which properly provides backup power for emergency starting once a vehicle has insufficient power to crank over the engine. The invention solves out the drawback of failing to starting the engine of a vehicle owing to insufficient power of a conventional backup battery. The design of the invention is that the battery has one more electrode than the original vehicle battery (i.e. extra 2 Volts) to prevent from the voltage drop problem caused by the wires and clamping apparatuses, in addition, provide voltage for easily starting the engine voltage and current. In the event that the vehicle battery has insufficient power to crank the engine, the battery is able to be carried out of the vehicle for charging and instant cranking the engine by connecting the battery to two clamping apparatuses with positive and negative poles.

### BACKGROUND OF THE INVENTION

1) Field of the Invention

This invention relates to an automotive engine-starting battery, in particular, a battery that has one more electrode (i.e. extra 2 Volts) adding to the original number of automotive battery voltages is positioned in a vehicle for connecting the car's battery and is plugged into the car's cigarette lighter adapter via an on-cehicle voltage-boosting charger for spontaneously charging by the control of voltage-boosting circuit. The invention is able to be carried for charging at home by a home charger to achieve the effect of emergency use. Once any vehicle battery has insufficient power to crank over the engine, the battery is able to be carried out of the vehicle for parallel connection with the vehicle battery by two clamping apparatuses having both positive and negative poles; in addition, the battery is able to directly be plugged into the cigarette lighter socket in a car for connecting to an current limit converter for charging to achieve the objective of instant cranking the vehicle engine.

2) Description of the Prior Art

Generally, the main purpose of a vehicle battery is to provide power supply for cranking the engine motor and other on-vehicle appliances when the engine is idle without enough electric power; on the contrary, as the rotational speed of the engine increases rapidly to generate a great quantity of electricity providing for on-vehicle appliances, the surplus electricity is able to supply for the battery. Among all on-vehicle appliances, the motor for starting the engine has the maximum power consumption; therefore, the engine is possibly unable to be started, once the automotive battery is dead or the lamp is forgotten to be turned off upon parking. In addition, an automotive battery discharges electricity when being unused for a long period of time, so as to cause to insufficient electricity. Hence, a vehicle is unable to be crank over under such situation.

A battery of conventional emergency power supply has the same voltage as an automotive battery with slightly smaller size. The charging of said battery applies the methods of either parallel connection with the automotive battery, or charging at home. When a vehicle battery has insufficient power to start the engine, the battery can be charged by clamping positive and negative poles of the vehicle to crank over the engine; however, the fact is that the backup battery for emergency starting is usually found insufficient, when the above situation happens, so as to fail to start the vehicle engine.

In view of the foregoing drawbacks, the present invention described herein provides a more practicable automotive engine-starting battery for emergency starting with a wider application.

### SUMMARY OF THE INVENTION

Differing from conventional backup battery, the present invention mainly comprises an automotive engine-starting battery, which can be stored in car for emergency use and plugged into the in-car cigarette lighter socket via an on-cehicle voltage-boosting charger to connect with the original in-car battery for spontaneously charging by the control of voltage-boosting circuit, thereby enabling the battery to be under the full-electricity condition at anytime for emergency use. In addition, as the battery has one more electrode than the original vehicle battery, the battery voltage of the invention is 2 Volt more than the original vehicle battery. Therefore, the battery is able to be carried out of the vehicle for parallel connection with the original vehicle battery by clamping both positive and negative poles of the clamping apparatuses, once the on-vehicle battery has insufficient electricity power to start the engine, in addition, the battery is able to directly be plugged into the cigarette lighter socket in a car for connecting to an current limit converter for charging to achieve the objective of instant cranking the vehicle engine.

Furthermore, the automotive battery for emergency starting of the invention can be carried indoors to be charged via a home charger to sustain the full electricity condition at anytime, when said battery has not been used for a long period of time. The automotive engine-starting battery of the invention is applicable to all kinds of transportation vehicles that can be started by vehicle motors. To achieve the above objectives, the invention mainly enables the automotive engine-starting battery to have one more electrode adding extra 2 Volt to the original vehicle battery voltages. In addition, the structure of the invention comprises: a set of clamping apparatuses with power outlets differing in length to clamp and charge the battery of a vehicle that is failed to have sufficient power to start the engine. The invention also can prevent the two ends of the clamping apparatuses from mutual collide against each other to cause short circuit happening. A on-cehicle voltage-boosting charger is able to control the voltage-boosting circuit for spontaneously charging the battery, thereby enabling the battery to be under the full-electricity condition at anytime for emergency use. A home charger connects to the municipal source electricity to enable the battery to be charged indoors for sustaining the full electricity condition at anytime. A current limit converter can be directly plugged into the in-car cigarette lighter socket for charging the battery of a vehicle that is failed to start the engine. Hence, the invention achieves the objectives of rapidly charging and instant cranking the engine.

Further aspects, objects, desirable features, and advantages of the invention will be better understood from the detailed description and drawings illustrated by way of example.

### BRIEF DESCRIPTION OF THE DRAWINGS

FIG. 1 is an exploded view of a preferred embodiment of the invention;

FIG. 2 is a perspective view showing the inner structure of a preferred embodiment of the invention;

FIG. 3 is a perspective view showing an outer structure of a preferred embodiment of the invention;

FIG. 4 is a schematic view showing the a preferred embodiment of the invention in action regulation;

FIG. 5 is perspective view of another embodiment according to the invention;

FIG. 6 is a perspective view of another embodiment of this invention; and

FIG. 7 is a perspective view of another embodiment of this invention.

### DETAILED DESCRIPTION OF THE PREFERRED EMBODIMENTS

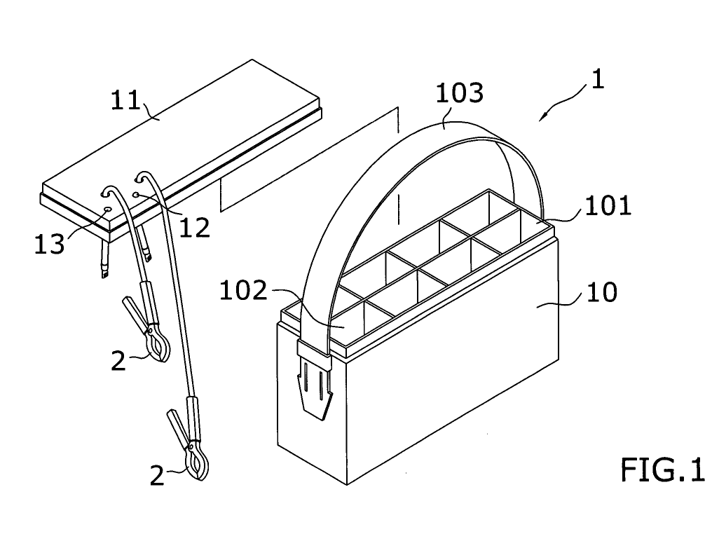

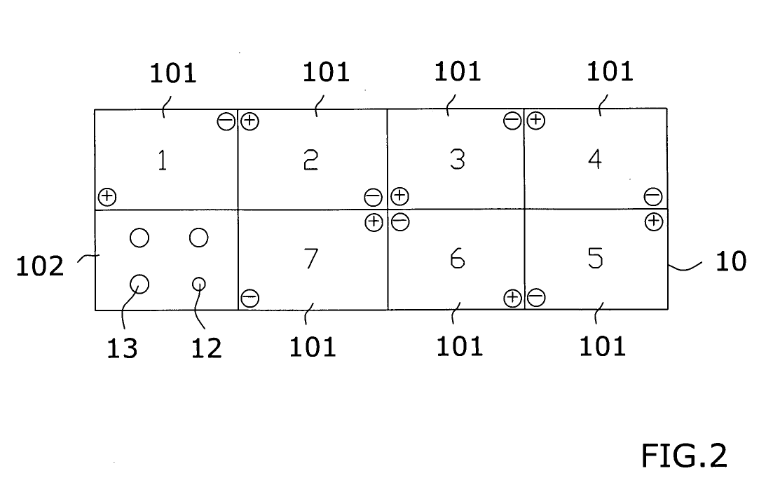

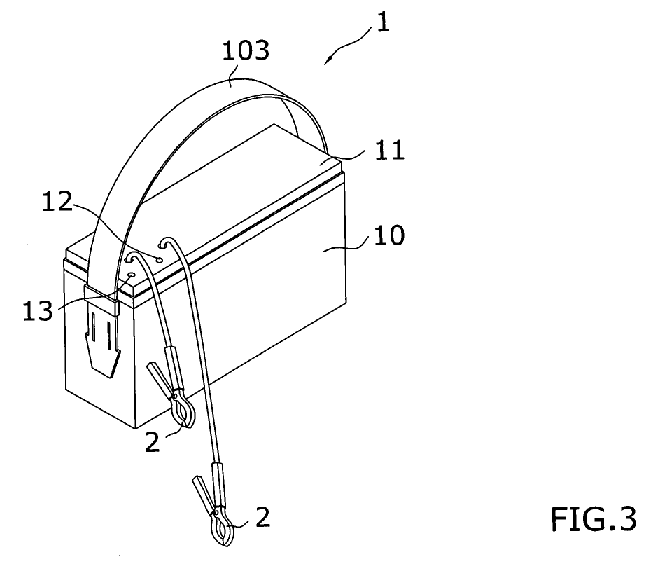

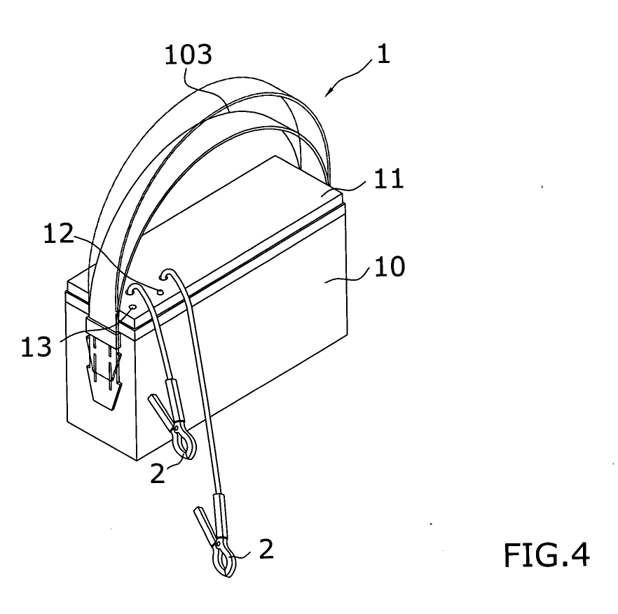

The automotive engine-starting battery (1) of the invention as shown in FIGS. 1 and 3 comprises a battery (10) and an upper cover (11). The battery (10) has seven electrodes (101) inside thereof, one more electrode (i.e. 2 Volt) and container (102) than a conventional standard battery, each of said electrodes (101) contains an electrolyte and a plate disposed as shown in FIG. 2. Said container (102) has a circuit board set inside thereof; the battery (10) has a ribbon (103) set outside thereof for easily being carried as shown in FIG. 4. The upper cover (11) has the surface thereof set four perforations, respectively enabling each set of clamping apparatuses (2) with positive and negative poles to pierce through the perforations, in addition, enabling a low-battery voltage warning light (12) and a vehicle power socket (13) that enables the circuit board connection for charging to be mounted thereon.

Each set of said clamping apparatuses (2) comprises power outlet wires with different lengths, thereby achieving the objective of clamping the battery of a vehicle that is failed to be started for charging, moreover, preventing the battery from causing short circuit happening when the clamping apparatuses (2) are carried.

When a vehicle battery has insufficient electricity power, the battery (1) is able to be carried out of the vehicle for parallel connection with the original vehicle battery that is failed to start the engine by clamping both positive and negative poles of the clamping apparatuses (2), thereby enabling the vehicle battery to be directly charged in accordance with the electric current flowing principle (high voltage flows to low voltage), or enabling the engine to be instantly started via the parallel connection with the original vehicle battery.

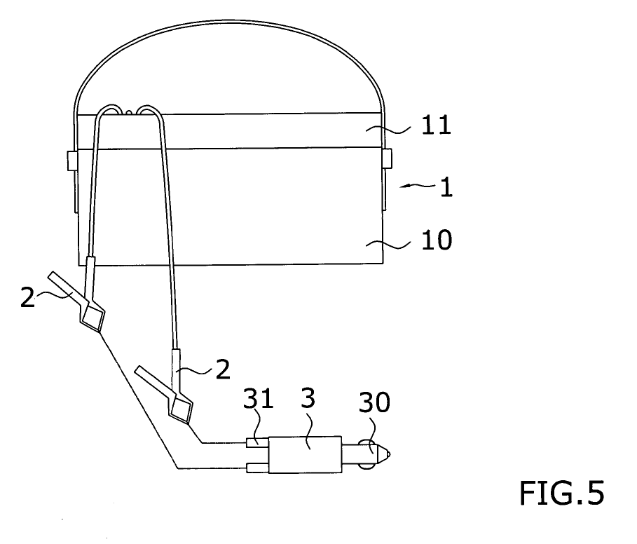

With reference to FIG. 5, the automotive battery (1) for emergency starting of the invention is able to comprises a current limit converter (3) with one end thereof having a terminal (30) and the other end thereof having both positive and negative poles (31). When a vehicle failed to start the engine, the driver does not need to get off the car, but clamps the clamping apparatuses (2) on respective positive and negative poles (31) of the current limit converter (3) and plugs said terminal (30) into the in-car cigarette lighter socket for charging the battery, so as to rapidly and instantly start the engine.

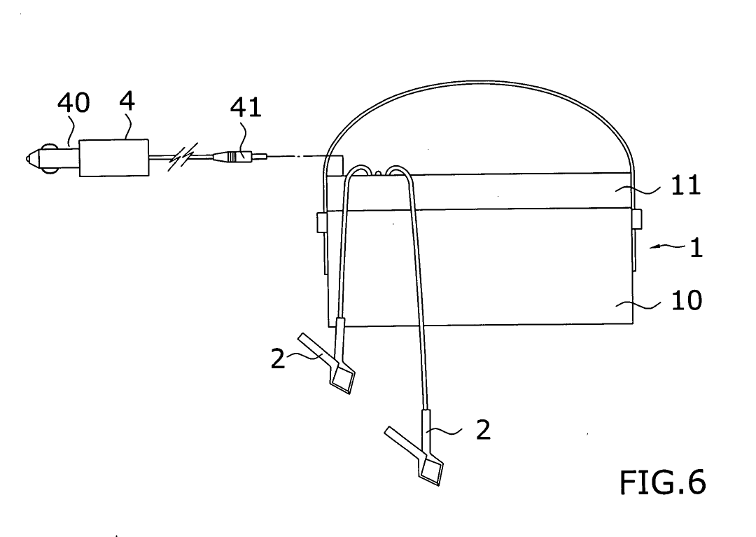

As shown in FIG. 6, the automotive battery (1) for emergency starting of the invention is able to comprise a on-cehicle voltage-boosting charger (4) having a voltage-boosting circuit inside thereof and a terminal (40) on one end outside thereof, in addition, a charging plug (41) is set on the other end thereof connecting to the on-cehicle voltage-boosting charger (4) with a wire. Hence, when a driver connects said emergency battery (1) to the original on-vehicle battery, the terminal (40) of the on-cehicle voltage-boosting charger (4) is plugged into the cigarette lighter socket and the charging plug (41) is plugged into the vehicle power socket (13), thereby the voltage-boosting circuit is able to increase the voltage to charge the battery (1) at anytime and sustain the battery (1) in full power condition for emergency starting.

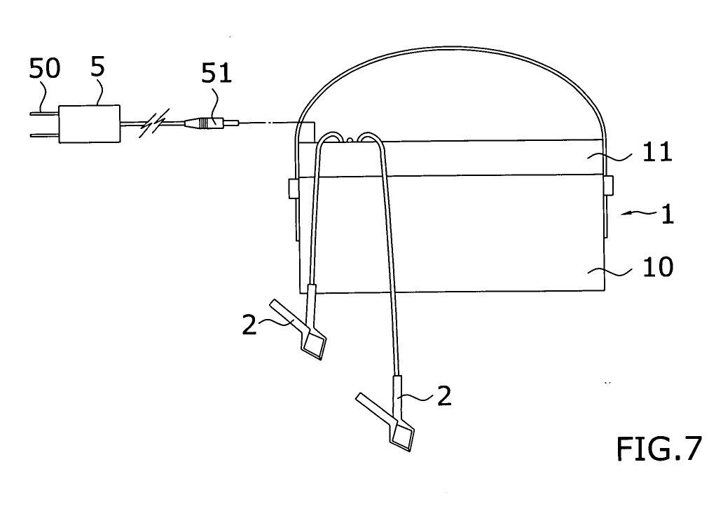

As shown in FIG. 7, the automotive battery (1) for emergency starting of the invention further comprises a home charger (5) that is applicable to AC110V/220VAC electricity, having one end thereof set a plug (50), the other end thereof set a charging plug (51) connected by a wire. Therefore, the battery (1) is able to be carried indoors for connecting a home charger (5) to the municipal source electricity for charging, in order to sustain the battery under the full-electricity condition at anytime.

Moreover, regardless of the battery voltages of different kinds of vehicle tools, the automotive battery (1) for emergency starting of the invention is 2 Volt more than the originally set vehicle voltage.

In conclusion, the invention applies one more electrode than the original vehicle battery to increase 2 Volt for parallelly connecting and charging the vehicle battery, without causing the insufficient electricity problem owing to voltage dropping when a conventional backup battery is parallelly connected for charging. Seeing that the invention has a higher voltage than the original vehicle battery, the battery voltage of a vehicle that fails to crank the engine is able to be boosted. The battery (1) of the vehicle battery (10) and the conventional battery of a vehicle that fails to crank the engine can combine with both electric currents to easily crank the engine.

New characteristics and advantages of the invention covered by this document have been set forth in the foregoing description. It is of course to be understood, however, that this disclosure is, in many respects, only illustrative. Changes may be made in details without exceeding the scope of the invention by those who are skilled in the art under the doctrine of equivalents. The scope of the invention is, of course, defined in the language in which the appended claims are expressed.

1. An automotive engine-starting battery to be electrically connected to a vehicle battery having a first voltage and N cells, wherein N is a positive integer greater than two, the automotive engine-starting battery comprising:
a battery unit having (N+1) cells and a second voltage substantially higher than the first voltage by two volts; and
a set of clamping apparatuses, each of which has a positive end and a negative end, for electrically connecting the battery unit to the vehicle battery.
